(19) United States
(12) Patent Application Publication
(10) Pub. No.: US 2014/0313545 A1
(43) Pub. Date: Oct. 23, 2014

(54) IMAGE FORMATION APPARATUS AND COMPUTER READABLE NON-TRANSITORY RECORDING MEDIUM STORING CONTROL PROGRAM FOR CONTROLLING IMAGE FORMATION APPARATUS

(71) Applicants: CASIO ELECTRONICS MANUFACTURING CO., LTD., Iruma-shi (JP); CASIO COMPUTER CO., LTD., Tokyo (JP)

(72) Inventor: Jun HASHIMOTO, Tokyo (JP)

(73) Assignees: CASIO ELECTRONICS MANUFACTURING CO., LTD., Iruma-shi (JP); CASIO COMPUTER CO., LTD., Tokyo (JP)

(21) Appl. No.: 14/251,230

(22) Filed: Apr. 11, 2014

(30) Foreign Application Priority Data
Apr. 19, 2013 (JP) 2013-088798

(51) Int. Cl. G06K 15/00; G06K 15/02

(52) U.S. Cl. CPC G06K 15/4005; G06K 15/1801
USPC 358/1.15

(57) ABSTRACT

An image formation apparatus includes: an imaging system synchronization signal generator which generates an imaging system synchronization signal for operating an image processing system mechanism; a feeding system synchronization signal generator which operates in synchronization with the imaging system synchronization signal generator, the feeding system synchronization signal generator generating a feeding system synchronization signal for operating a feeding system mechanism; an imaging system synchronization signal period setter which sets, as a plurality of periods of the imaging system synchronization signal, a first plurality of different periods being predetermined in accordance with a plurality of modes of the image processing, for the imaging system synchronization signal generator; and a feeding system synchronization signal period setter which sets, as a period of the feeding system synchronization signal, a common single period being common to a plurality of modes of the image processing, for the feeding system synchronization signal generator.

### CROSS-REFERENCE TO RELATED APPLICATION

This application claims the benefit of Japanese Patent Application No. 2013-088798, filed on Apr. 19, 2013, the entire disclosure of which is incorporated by reference herein.

### FIELD

This application relates to an image formation apparatus and a computer readable non-transitory recording medium storing a control program for controlling the image formation apparatus.

### BACKGROUND

A printer apparatus comprises an image processing system mechanism which performs image processing on video data to generate head data for driving a head and controls the head using the head data to perform a printing process, and a feeding system mechanism which controls feeding of paper sheets in accordance with the printing process. Since the image processing system mechanism and the feeding system mechanism need to be controlled in synchronization with each other, a circuit for generating a synchronization signal for the synchronization is required.

For example, as described in Unexamined Japanese Patent Application Kokai Publication No. 2006-159851, a conventional printer apparatus uses a single synchronization signal to control both of the image processing system mechanism and the feeding system mechanism. Accordingly, for example, a synchronization signal for the image processing system mechanism cannot be changed to an arbitrary frequency while maintaining a synchronization signal for the feeding system mechanism at a constant frequency.

As a printer apparatus is sophisticated, more varieties of modes of image processing such as an image resolution of 600 dpi (dots per inch) or 1200 dpi and multiple gray levels have been demanded for printing process. In these cases, the image processing system mechanism needs to divide one dot into a plurality of fine pixels to perform head control and the like, and therefore requires a synchronization signal having a period depending on a mode of image processing.

On the other hand, the feeding system mechanism requires synchronization control independent of the image processing system mechanism, while being in synchronization with the image processing system mechanism.

Accordingly, there has been a problem that whenever a period of a synchronization signal is changed depending on a mode of image processing, processing for the synchronization signal in the feeding system mechanism needs to be changed, which, in connection with varieties of combinations of resolutions and grayscales in image processing as well as a choice of paper and throughput in the feeding system mechanism, results in increase in complexity of program processing for the synchronization signal.

### SUMMARY

An image formation apparatus according to the present disclosure comprises:

an image processing system mechanism which performs image processing on video data to generate head data for driving a head and controls the head using the head data to perform a printing process on a printing medium;

a feeding system mechanism which controls feeding of the printing medium during the printing process;

an imaging system synchronization signal generator which generates an imaging system synchronization signal for operating the image processing system mechanism;

a feeding system synchronization signal generator which operates in synchronization with the imaging system synchronization signal generator, the feeding system synchronization signal generator generating a feeding system synchronization signal for operating the feeding system mechanism;

an imaging system synchronization signal period setter which sets, as a plurality of periods of the imaging system synchronization signal, a first plurality of different periods being predetermined in accordance with a plurality of modes of the image processing, for the imaging system synchronization signal generator; and

a feeding system synchronization signal period setter which sets, as a period of the feeding system synchronization signal, a common single period being common to a plurality of modes of the image processing, for the feeding system synchronization signal generator.

A computer readable non-transitory recording medium storing a control program according to the present disclosure stores a program for controlling an image formation apparatus comprising an image processing system mechanism performing image processing on video data to generate head data for driving a head and controlling the head using the head data to perform a printing process on a printing medium and a feeding system mechanism controlling feeding of the printing medium during the printing process, the control program causing a computer to:

generate an imaging system synchronization signal for operating the image processing system mechanism;

generate a feeding system synchronization signal being in synchronization with the imaging system synchronization signal, the feeding system synchronization signal for operating the feeding system mechanism;

set, as a plurality of periods of the imaging system synchronization signal, a first plurality of different periods being predetermined in accordance with a plurality of modes of the image processing; and

set, as a period of the feeding system synchronization signal, a common single period being common to a plurality of modes of the image processing.

### BRIEF DESCRIPTION OF THE DRAWINGS

A more complete understanding of this application can be obtained when the following detailed description is considered in conjunction with the following drawings, in which:

FIG. 1 is a diagram illustrating an exemplary system configuration according to an embodiment of the present disclosure;

FIG. 2 is a diagram illustrating an exemplary configuration of a feeding system mechanism in the present embodiment;

FIG. 3 is a diagram illustrating an exemplary configuration of a head controller in the present embodiment;

FIG. 4 is a diagram illustrating an exemplary configuration of a basic timing generator in the present embodiment;

FIG. 5 is a timing chart illustrating an exemplary operation at an image resolution of 1200 dpi according to the present embodiment;

FIG. 6 is a timing chart illustrating an exemplary operation at an image resolution of 600 dpi according to the present embodiment;

FIGS. 7A to 7C are diagrams illustrating exemplary counter settings in the present embodiment;

FIGS. 8A and 8B are diagrams (1 of 3) illustrating effects of the present embodiment;

FIGS. 9A and 9B are diagrams (2 of 3) illustrating effects of the present embodiment; and

FIGS. 10A to 10C are diagrams (3 of 3) illustrating effects of the present embodiment.

### DETAILED DESCRIPTION

In the following, an embodiment of the present disclosure will be described in detail with reference to the drawings.

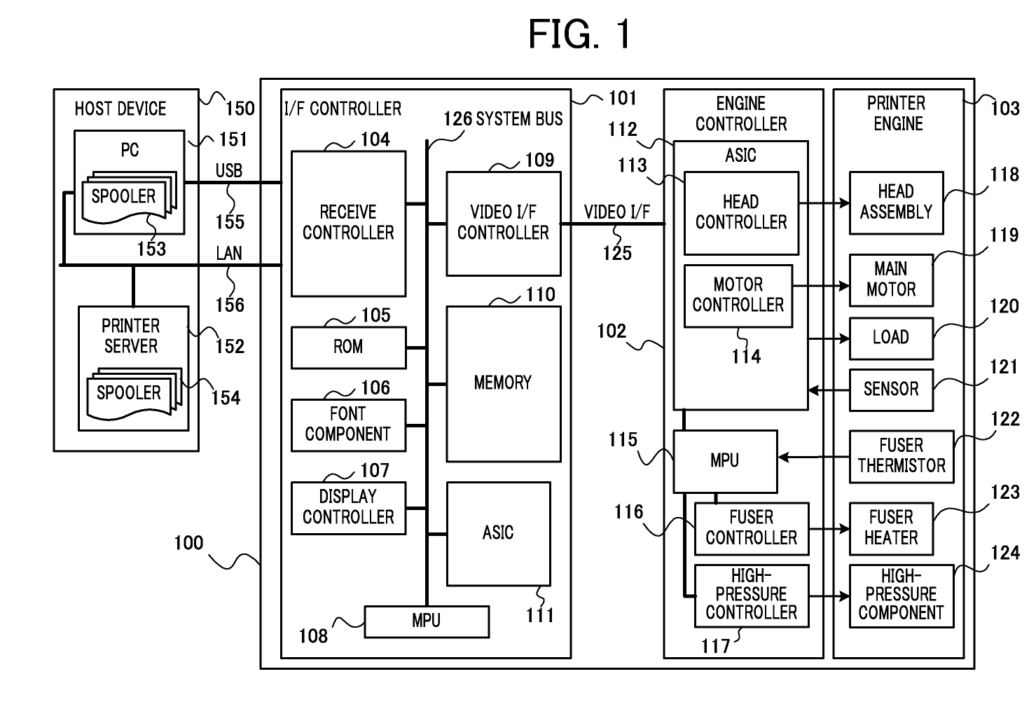

FIG. 1 is a diagram illustrating an exemplary system configuration according to an embodiment of the present disclosure.

A host device 150 comprises a personal computer (hereinafter referred to as “PC”) 151 and a printer server 152. A printer apparatus 100 and the PC 151 are interconnected through a USB (Universal Serial Bus) interface 155. The printer apparatus 100 and the printer server 152 are interconnected through a LAN (Local Area Network) 156. Note that the printer apparatus 100 and the PC 151 may be interconnected through the LAN 156, and the PC 151 and the printer server 152 may be interconnected through the LAN 156.

When printing is executed from an application program, not specifically depicted, running on the PC 151, the PC 151 temporarily stores command data, being output from the application program through a printer driver, in a spooler 153 in the PC 151 while converting the command data. If the PC 151 and the printer apparatus 100 are interconnected through the USB interface 155, the command data is directly sent from the spooler 153 in the PC 151 to the printer apparatus 100. If printing is executed through the printer server 152 connected through the LAN 156, the data stored in the spooler 153 in the PC 151 is transferred to a spooler 154 in the printer server 152, and the command data is sent from the spooler 154 to the printer apparatus 100.

The printer apparatus 100 comprises an I/F (interface) controller 101, an engine controller 102, and a printer engine 103.

The I/F controller 101 comprises a receive controller 104, a ROM (Read Only Memory) 105, a font component 106, a display controller 107, a MPU (Micro Processing Unit) 108, a video I/F (interface) controller 109, a memory 110, an ASIC (Application Specific Integrated Circuit) 111, and a system bus 126 which interconnects these components.

The MPU 108 executes a control program stored in the ROM 105 to control operations of the entire I/F controller 101. When an error or the like occurs, the MPU 108 provides a display to the display controller 107.

The receive controller 104 receives the command data from the host device 150 and transfers the command data to a receive buffer (not depicted) in the memory 110 via DMA (Direct Memory Access). The receive controller 104 also notifies the host device 150 of status of the printer apparatus 100.

The MPU 108 analyzes the command data in the receive buffer in the memory 110, uses font data stored in the font component 106 to convert the data into video data (bitmap data), and draws (stores) the video data in a drawing area in the memory 110.

When drawing of one page by the MPU 108 is completed, the video I/F controller 109 directs the engine controller 102 to start printing and transfers the video data in the drawing area in the memory 110 line by line to the engine controller 102 via DMA in synchronization with a horizontal synchronization signal (HSYNC) from the engine controller 102. Further, the video I/F controller 109 receives a printer engine specification such as selection of a paper feed tray and a specification of a resolution, and a printer engine state such as a paper jam.

The ASIC 111 in the I/F controller 101 controls the system bus 126 when each control select (chip select) or DMA control is performed. The ASIC 111 also performs compression and decompression of drawing data in the memory 110 and transfer of video data to the engine controller 102 by DMA control.

The engine controller 102 comprises an ASIC 112 including a head controller 113 and a motor controller 114, an MPU 115, a fuser controller 116, and a high-pressure controller 117.

The printer engine 103 comprises a head assembly 118, a main motor 119, a load 120, a sensor 121, a fuser thermistor 122, a fuser heater 123, and a high-pressure component 124.

The ASIC 112 in the engine controller 102 sends head data to the head assembly 118 in the printer engine 103 to cause the head assembly 118 to form an image on a photoconductor while controlling print timing of one line by the head controller 113. The ASIC 112 controls the main motor 119 in the printer engine 103 by using the motor controller 114. The ASIC 112 controls the load 120 in the printer engine 103, such as a paper feed solenoid and a wait clutch. The ASIC 112 detects paper feed, paper ejection, presence or absence of paper, a paper size, unit information and the like through a variety of the sensors 121 in the printer engine 103.

The MPU 115 is a one-chip microcomputer containing a ROM, a RAM (Random Access Memory), and an A/D (analog-digital) converter. The MPU 115 calculates a value for the fuser thermistor 122 in the printer engine 103 through the A/D converter in the MPU 115 and controls the fuser heater 123 in the printer engine 103 through the fuser controller 116 based on the calculated value to perform fuser temperature control.

When the video I/F controller 109 in the I/F controller 101 directs start of printing, the motor controller 113 in the ASIC 112 causes the main motor 119 in the printer engine 103 to rotate, thereby allowing a paper sheet to be fed. Further, the ASIC 112 detects, through the sensor 121, that an edge of the paper sheet reaches a position at which image formation can be performed and notifies the video I/F controller 109 in the I/F controller 101 of the detection. Then, the ASIC 112 outputs a horizontal synchronization signal to the I/F controller 101 and sends head data to the head assembly 118 in the printer engine 103 to form an image.

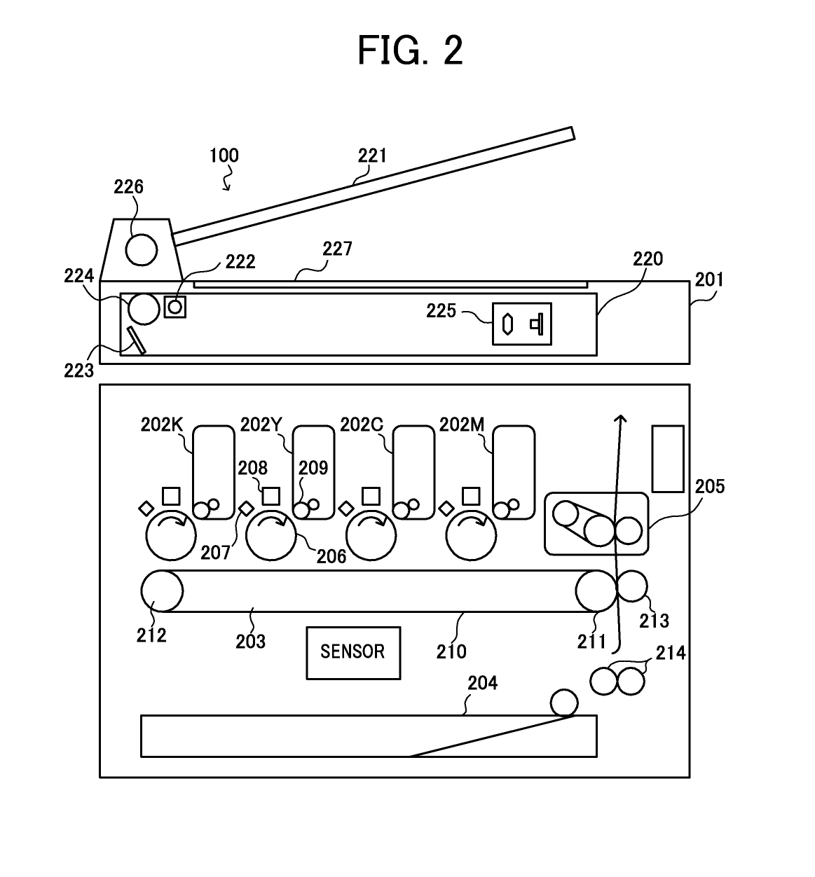

FIG. 2 is a schematic cross-sectional view of the printer apparatus 100 in FIG. 1.

In FIG. 2, the printer apparatus 100 includes an image scanner 201, an image former 202, an intermediate transfer medium 203, a paper feeder 204, and a fuser 205. The image scanner 201 is disposed at the top. The image former 202 has a configuration in which four image formation units, namely image formation units 202M (magenta image formation unit), 202C (cyan image formation unit), 202Y (yellow image formation unit), and 202K (black image formation unit), are disposed side by side in this order from the right-hand side of the page of FIG. 2 to the left-hand side. Note that the magenta (M), cyan (C), and yellow (Y) image formation units 202M to 202Y are respectively used for color printing by subtractive color mixing and the black (K) image formation unit 202K is used for monochrome printing.

The image formation units 202M to 202K have the same configuration except for (color of) toner contained in a development container, and for each unit, a photoconductor drum 206, a charger 207 disposed near a circumferential surface of the photoconductor drum 206, a print head 208 corresponding to the head assembly 118 in FIG. 1, and a developer roller 209 are disposed in this order. The photoconductor drum 206 is rotated in the direction indicated by an arrow, charge is applied from the charger 207 to form an electrostatic latent image on the circumferential surface of the photoconductor drum 206 by optical writing based on print information from the print head 208, and a toner image is formed by development processing with the developer roller 209.

The intermediate transfer medium 203 comprises a transfer belt 210, and a driver roller 211 and a driven roller 212 that rotate the transfer belt 210. The toner image formed on the photoconductor drum 206 is transferred to the transfer belt 210 and is sent to a transferrer 213 by drive of the driver roller 211. A sheet of paper fed from the paper feeder (paper feed tray) 204 is supplied to the transferrer 213 by a feeding roller 214, and then the toner image on the transfer belt 210 is transferred to the paper sheet and is fused on the paper sheet by heat with the fuser 205.

On the other hand, the image scanner 201 is equipped with a document scanning unit 220 and an ADF (Auto Document Feeder) 221. The document scanning unit 220 is equipped with a light source 222, a minor 223, a platen motor 224, and a CCD unit 225. The platen motor 224 is actuated to scan an image of a document placed on a platen glass 227.

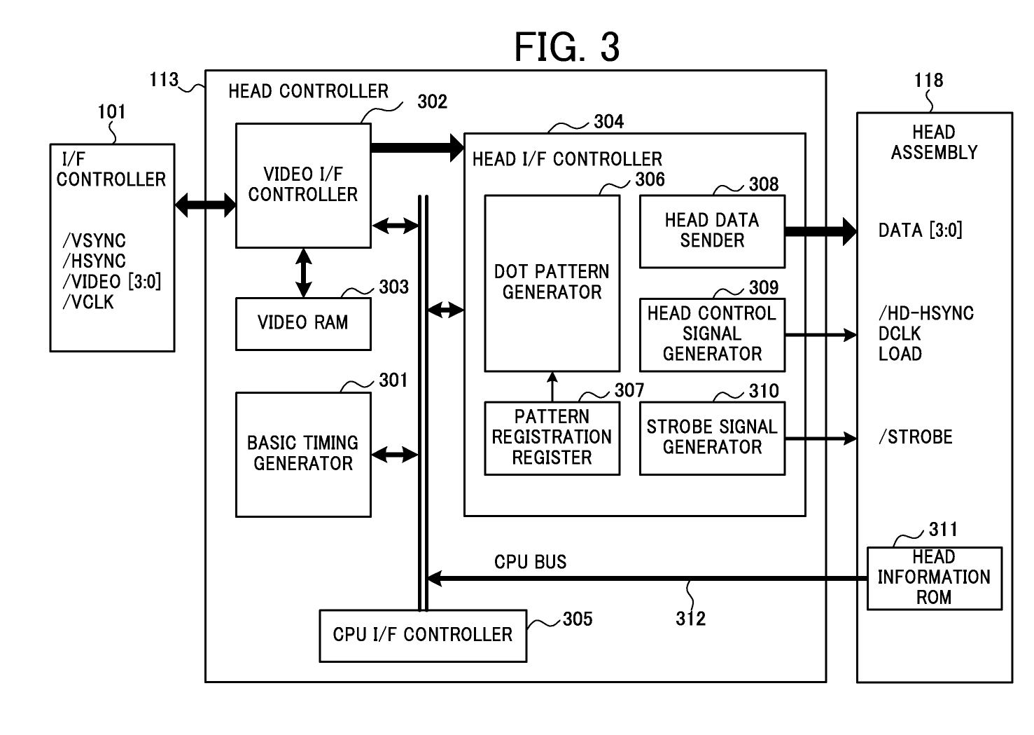

FIG. 3 is a diagram illustrating an exemplary configuration of the head controller 112 in FIG. 1. The head controller 112 comprises a basic timing generator 301, a video I/F controller 302, a video RAM (Random Access Memory) 303, a head I/F controller 304, and a CPU I/F controller 305. Further, the head I/F controller 304 comprises a dot pattern generator 306, a pattern registration register 307, a head data sender 308, a head control signal generator 309, and a strobe signal generator 310.

The video I/F controller 302 stores video data received from the I/F controller 101 (FIG. 1) in the video RAM 303 and sequentially transfers the video data to the dot pattern generator 306 in the head I/F controller 304 in response to a request from the dot pattern generator 306.

The dot pattern generator 306 reads dot pattern data set in the pattern registration register 307 based on each grayscale value to transform one pixel of the video data input from the video I/F controller 302 into n fine pixels respectively in a vertical scanning direction, thereby generating dot pattern data.

The head data sender 308 in the head I/F controller 304 sequentially transfers the dot pattern data generated by the dot pattern generator 306 to the head assembly 118 (refer to FIG. 1) in accordance with a dot clock (DCLK) instruction from the head control signal generator 309.

The strobe signal generator 310 divides the vertical scanning direction into n in accordance with grayscale information set by the CPU I/F controller 305 and generates a strobe signal according to each request. For example, if the vertical scanning direction is divided into two, the strobe signal generator 310 generates two strobe timing signals: sub-lines (1/2) and (2/2); if the vertical scanning direction is divided into three, the strobe signal generator 310 generates three strobe timing signals: sub-lines (1/3), (2/3) and (3/3).

The CPU I/F controller 305 performs address decoding, and reading and writing of registers of respective modules and I/O (input and output) ports.

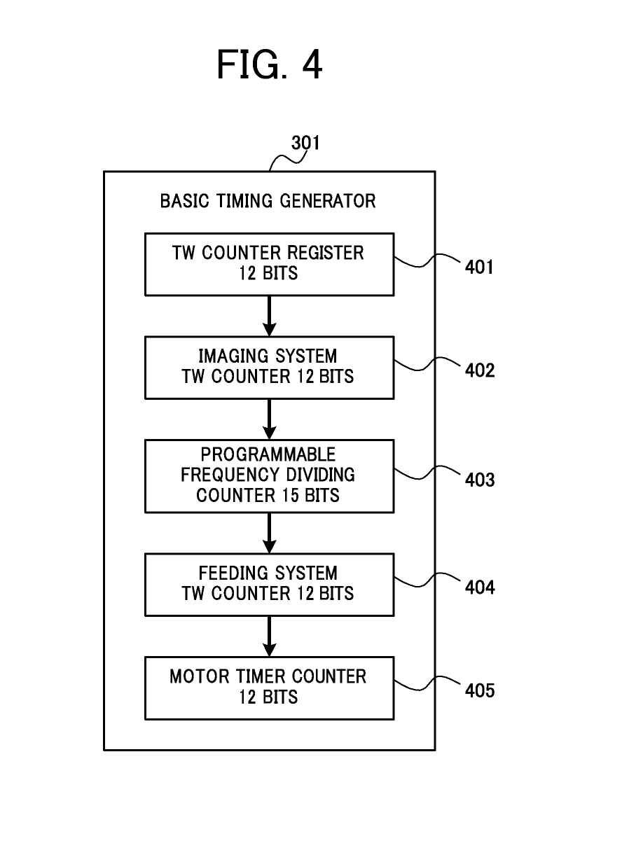

FIG. 4 is a diagram illustrating an exemplary configuration of the basic timing generator 301 in FIG. 3.

An imaging system TW counter 402 functions as a first counter, which is an imaging system synchronization signal generator, and is a 12-bit counter circuit that counts up a counter value based on a basic clock (not depicted) which is a first clock signal and outputs, as an imaging system synchronization signal /TWOUT, a signal whose edge changes at the timing when the counter value reaches a reset counter value and is reset.

The imaging system TW counter 402 divides the vertical scanning direction into n (one pixel is divided into two, three, or the like in the vertical scanning direction) in accordance with grayscale information set by the CPU I/F controller 305 to generate, as an imaging system synchronization signal /TWOUT, a basic timing according to each throughput. The imaging system synchronization signal /TWOUT serves as a synchronization signal for head data when video data is transformed to a dot pattern (fine pixels).

Based on the imaging system synchronization signal /TWOUT, the head control signal generator 309 in FIG. 3 generates a head control signal such as a horizontal synchronization signal /HD-HSYNC, a dot clock signal DCLK, and a strobe signal /STROBE.

A TW counter register 401 functions as an imaging system synchronization signal period setter and is a counter register circuit that sets a reset counter value for the imaging system TW counter 402 such that a period of the imaging system synchronization signal /TWOUT output from the imaging system TW counter 402 varies depending on a mode of image processing such as a combination of an image resolution and a grayscale value, for example. The TW counter register 401 functions to set a period of the imaging system synchronization signal /TWOUT for the imaging system TW counter 402, which is an imaging system synchronization signal generator, depending on a mode of image processing.

A feeding system TW counter 404 functions as a second counter, which is a feeding system synchronization signal generator, and is a counter circuit that counts up a counter value based on a basic clock signal or a clock signal that is in synchronization with the basic clock signal and outputs, as a feeding system synchronization signal /TWOUT, a signal whose edge changes at the timing when the counter value is reset by a reset signal.

A programmable frequency dividing counter 403 functions as a feeding system synchronization signal period setter and is a counter circuit that divides a frequency of the basic clock at a frequency division ratio that is set so that a period of the feeding system synchronization signal /TWOUT becomes equal to a predetermined period (approximately one or two constant periods) regardless of a mode of image processing, and outputs a reset signal for resetting the feeding system TW counter 404. The programmable frequency dividing counter 403 functions to set a period of the feeding system synchronization signal /TWOUT for the feeding system TW counter 404, which is a feeding system synchronization signal generator, so that the period of the feeding system synchronization signal /TWOUT becomes equal to a predetermined period regardless of a mode of image processing.

A motor timer counter 405 is a counter circuit that controls operations of the main motor 119 in the printer engine 103 in FIG. 1.

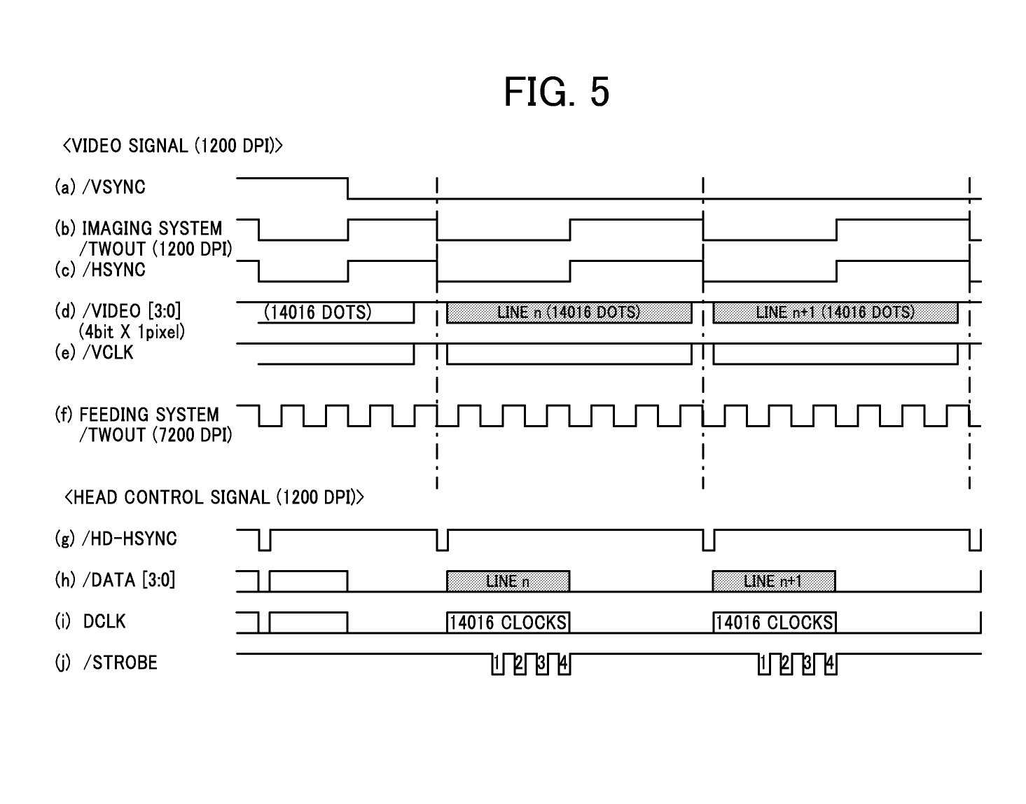

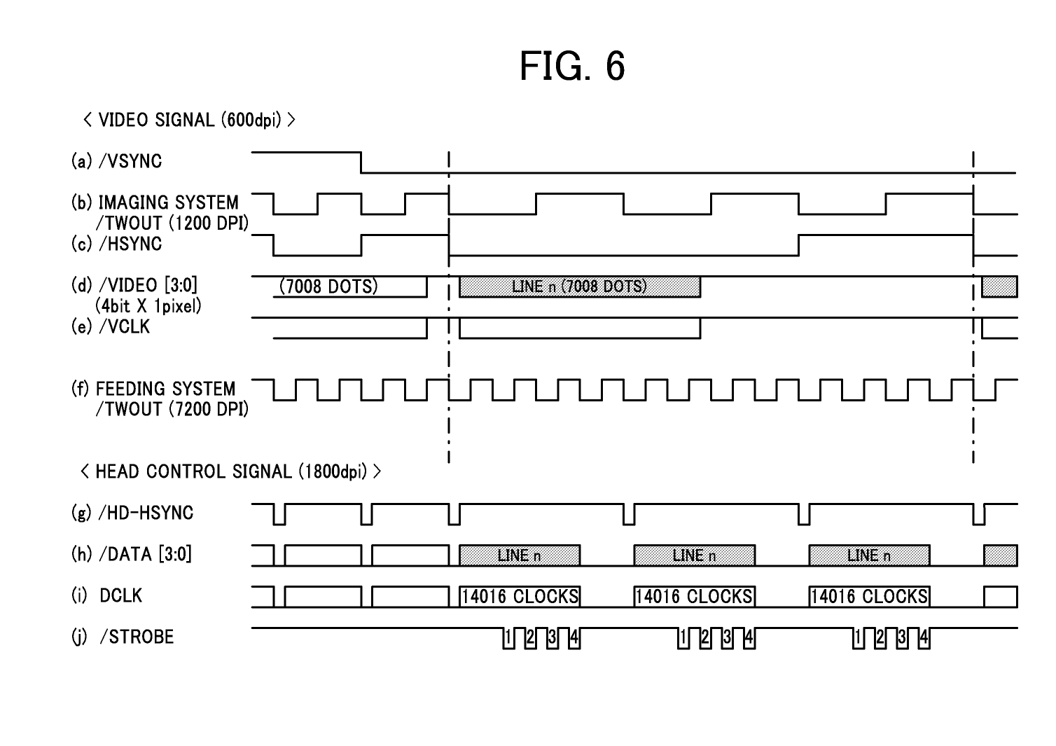

FIG. 5 is a timing chart illustrating an exemplary operation at an image resolution of 1200 dpi according to the present embodiment and FIG. 6 is a timing chart illustrating an exemplary operation at an image resolution of 600 dpi according to the present embodiment.

As illustrated as (a) and (c) in FIG. 5 or 6, the video I/F controller 302 in FIG. 3 outputs a vertical synchronization signal /VSYNC and a horizontal synchronization signal /HSYNC to the I/F controller 101.

On the other hand, as illustrated as (d) and (e) in FIG. 5 or 6, the video I/F controller 302 receives, from the I/F controller 101, prescribed number of dots of video data /VIDEO [3:0] depending on a resolution in synchronization with a video clock /VCLK. At an image resolution of 1200 dpi given in FIG. 5, an amount of video data /VIDEO [3:0] transferred at a time is one line=14016 dots. At an image resolution of 600 dpi given in FIG. 6, an amount of video data /VIDEO [3:0] transferred at a time is one line of video data /VIDEO [3:0]=7008 dots, which is a resolution half as high as 1200 dpi.

As illustrated in (b), (g), (i), and (j) in FIG. 5 or 6, the head control signal generator 309 in the head I/F controller 304 in FIG. 3 generates a horizontal synchronization signal /HD-HSYNC, a dot clock signal DCLK, and a strobe signal /STROBE in synchronization with the imaging system synchronization signal /TWOUT output from the imaging system TW counter 402 (refer to FIGS. 3 and 4) in the basic timing generator 301.

The dot pattern generator 306 in the head I/F controller 304 in FIG. 3 transforms each piece of dot data of video data /VIDEO [3:0] into n pieces of fine pixel data to generate head data /DATA [3:0]. Then, as illustrated as (g), (h) and (i) in FIG. 5 or 6, the dot pattern generator 306 transfers the head data /DATA [3:0] to the head assembly 118 (refer to FIGS. 1 and 3) in synchronization with the horizontal synchronization signal /HD-HSYNC and the dot clock DCLK generated by the head control signal generator 309.

The head assembly 118 (FIGS. 1 and 3) exposes the head for a prescribed time duration in synchronization with the strobe signal /STROBE output from the head control signal generator 309 in the head I/F controller 304 in FIG. 3, and performs a printing process.

As illustrated as (b) in FIGS. 5 and 6, the imaging system TW counter 402 (FIG. 4) in the basic timing generator 301 (FIG. 3) outputs, as an imaging system synchronization signal /TWOUT, a synchronization signal having a period that varies depending on resolution of an image, such as 1200 dpi (FIG. 5) or 600 dpi (FIG. 6). On the other hand, as illustrated as (f) in FIGS. 5 and 6, the feeding system TW counter 404 (FIG. 4) in the basic timing generator 301 (FIG. 3) outputs, as a feeding system synchronization signal /TWOUT, a synchronization signal having a constant period (equivalent to 7200 dpi) regardless of resolution of an image. Accordingly, the ASIC 112 in the engine controller 102 in FIG. 1 can control the feeding system mechanism, including the fuser 205, the photoconductor drum 206, the developer roller 209, the transfer belt 210, the driver roller 211, the driven roller 212, the transferrer 213, and the feeding roller 214 as given in FIG. 2, in synchronization with the feeding system synchronization signal /TWOUT having the constant period.

This allows setting of a control program for the feeding system mechanism in the ASIC 112 to be simplified.

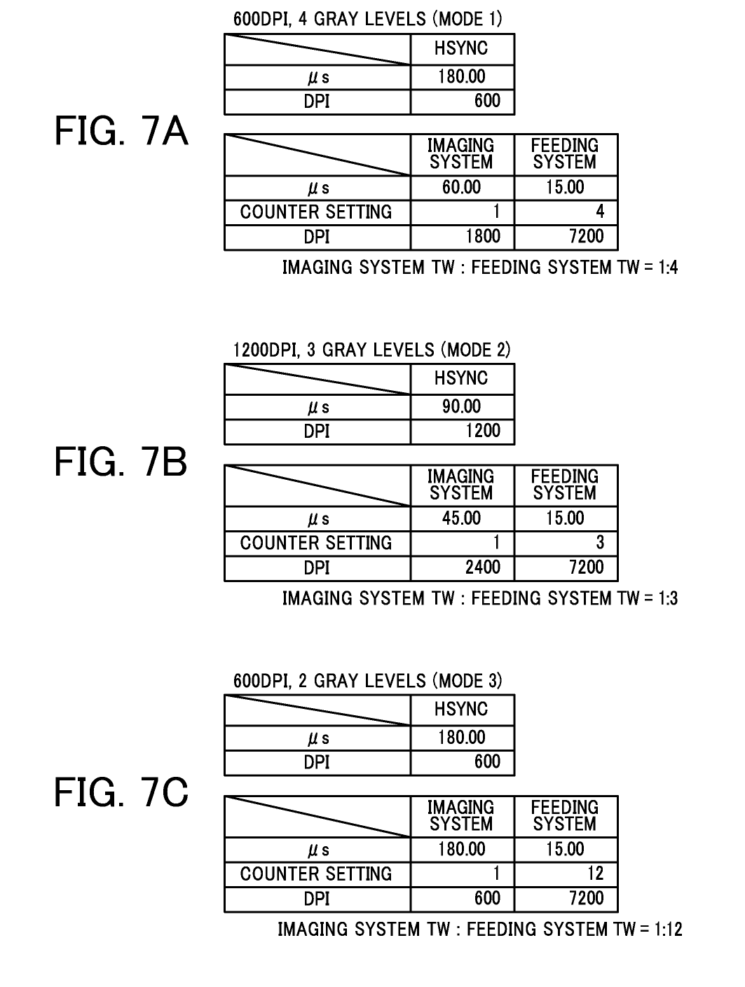

FIGS. 7A to 7C are diagrams illustrating exemplary counter settings for the basic timing generator 301 according to the present embodiment in a mode where the throughput of the feeding system mechanism is 50 ppm (a linear speed of 236 mm/second), the image resolution is 600 dpi, and the grayscale value is 4 (hereinafter referred to as mode 1), a mode where the image resolution is 1200 dpi and the grayscale value is 3 (hereinafter referred to as mode 2), and a mode where the image resolution is 600 dpi and the grayscale value is 2 (hereinafter referred to as mode 3) respectively.

Mode 1, that is, a case in FIG. 7A where the image resolution is 600 dpi and the grayscale value is 4 will be described first. The horizontal synchronization signal /HSYNC is set to 600 dpi and 180.00 μs (1 microsecond=one millionth of a second) in period. At a grayscale value of 4, the vertical scanning direction is divided into three, therefore the period of the imaging system synchronization signal /TWOUT is preferably ⅓ of the period of the horizontal synchronization signal /HSYNC and is set to 60.00 μs, for example. This period for the imaging system corresponds to 1800 dpi. Since the imaging system TW counter 402 in FIG. 4 is reset and generates a changing edge of the imaging system synchronization signal /TWOUT every ½ period, the imaging system TW counter 402 is preferably reset at 30.00 μs. The imaging system TW counter 402 counts up in accordance with the basic clock. If the basic clock is 50 MHz (1 megahertz=1 million hertz), for example, 1 count-up time of the imaging system TW counter=1 basic clock period= 1/50 MHz=0.02 μs. Therefore, a count-up value that is reset at 30.00 μs is: 30.00 μs/0.02 μs=1500 counts. This value is preferably set in the TW counter register 401 in FIG. 4.

On the other hand, it is desirable that the period of the feeding system synchronization signal /TWOUT is maintained, for example, at 15.00 μs which corresponds to 7200 dpi. This value (7200 dpi) is derived from the least common multiple of 1800 dpi which corresponds to the period of the imaging system synchronization signal /TWOUT in mode 1, 2400 dpi which corresponds to each period of the imaging system synchronization signal /TWOUT in mode 2, which will be described later, and 600 dpi which corresponds to each period of the imaging system synchronization signal /TWOUT in mode 3, which will be described later. Note that the period of the feeding system synchronization signal /TWOUT does not necessarily need to be the least common multiple, but needs to be a common multiple of resolutions corresponding to the periods of the imaging system synchronization signal /TWOUT of the respective modes. The feeding system TW counter 404 in FIG. 4 is also reset and generates a changing edge of the feeding system synchronization signal /TWOUT every ½ period. Accordingly, the feeding system TW counter 404 is preferably reset at 7.50 μs by an output from the programmable frequency dividing counter 403. Both of the feeding system TW counter 404 and the programmable frequency dividing counter 403 count up in accordance with the basic clock, and one period of the basic clock is 0.02 μs, for example, as described above. Therefore, in order for the programmable frequency dividing counter 403 to divide the frequency of the basic clock to output a clock signal having a period of 7.50 μs, a frequency division ratio 7.50 μs/0.02 μs=375 is preferably set for the programmable frequency dividing counter 403.

In this way, if the image resolution is 600 dpi and the grayscale value is 4 as given in FIG. 7A, settings are made such that a ratio between frequencies of the imaging system synchronization signal /TWOUT and the feeding system synchronization signal /TWOUT is 1:4 (a ratio between the count values described above is 375:1500).

Mode 2, that is, a case in FIG. 7B where the image resolution is 1200 dpi and the grayscale value is 3 will be described next. The horizontal synchronization signal /HSYNC is set to 1200 dpi and 90.00 μs in period. At a grayscale value of 3, the vertical scanning direction is divided into two (n=2), therefore the period of the imaging system synchronization signal /TWOUT is preferably ½ of the period of the horizontal synchronization signal /HSYNC and is set to 45.00 μs, for example. This period for the imaging system corresponds to 2400 dpi. The imaging system TW counter 402 is reset and generates a changing edge of the imaging system synchronization signal /TWOUT every ½ period and therefore is preferably reset at 22.50 μs. Therefore, a count-up value that is reset at 22.50 μs is: 22.50 μs/0.02 μs=1125 counts. This value is preferably set in the TW counter register 401.

On the other hand, it is desirable that the period of the feeding system synchronization signal /TWOUT is maintained at 15.00 μs, for example, which corresponds to 7200 dpi regardless of the image resolution. Therefore, a frequency division ratio, 375, that is the same as the case of 600 dpi, is preferably set for the programmable frequency dividing counter 403.

In this way, if the image resolution is 1200 dpi and the grayscale value is 3 as given in FIG. 7B, settings are made such that a ratio between frequencies of the imaging system synchronization signal /TWOUT and the feeding system synchronization signal /TWOUT is 1:3 (a ratio between the count values described above is 375:1125).

Mode 3, that is, a case in FIG. 7C where the image resolution is 600 dpi and the grayscale value is 2 will be furthermore described. The horizontal synchronization signal /HSYNC is set to 600 dpi and 180.00 μs in period. At a grayscale value of 2, the vertical scanning direction is not divided (n=1), therefore the period of the imaging system synchronization signal /TWOUT is preferably equal to the period of the horizontal synchronization signal /HSYNC and is set to 180.00 μs, for example. This period of the imaging system corresponds to 600 dpi. The imaging system TW counter 402 is reset and generates a changing edge of the imaging system synchronization signal /TWOUT every ½ period and therefore is preferably reset at 90.00 μs. Therefore, a count-up value that is reset at 90.00 μs is: 90.00 μs/0.02 μs=4500 counts. This value is preferably set in the TW counter register 401.

On the other hand, it is desirable that the period of the feeding system synchronization signal /TWOUT is maintained at 15.00 μs, for example, which corresponds to 7200 dpi regardless of the image resolution. Therefore, a frequency division ratio, 375, that is the same as the case of 600 dpi, is preferably set for the programmable frequency dividing counter 403.

In this way, if the image resolution is 600 dpi and the grayscale value is 2 as given in FIG. 7C, settings are made such that a ratio between frequencies of the imaging system synchronization signal /TWOUT and the feeding system synchronization signal /TWOUT is 1:12 (a ratio between the count values described above is 375:4500).

In the way above, in the present embodiment, a frequency division ratio for the programmable frequency dividing counter 403 is preferably set so that the frequency of the feeding system synchronization signal /TWOUT is equal to the least common multiple of the respective frequencies of the imaging system synchronization signal /TWOUT that vary depending on a mode such as resolution of image processing.

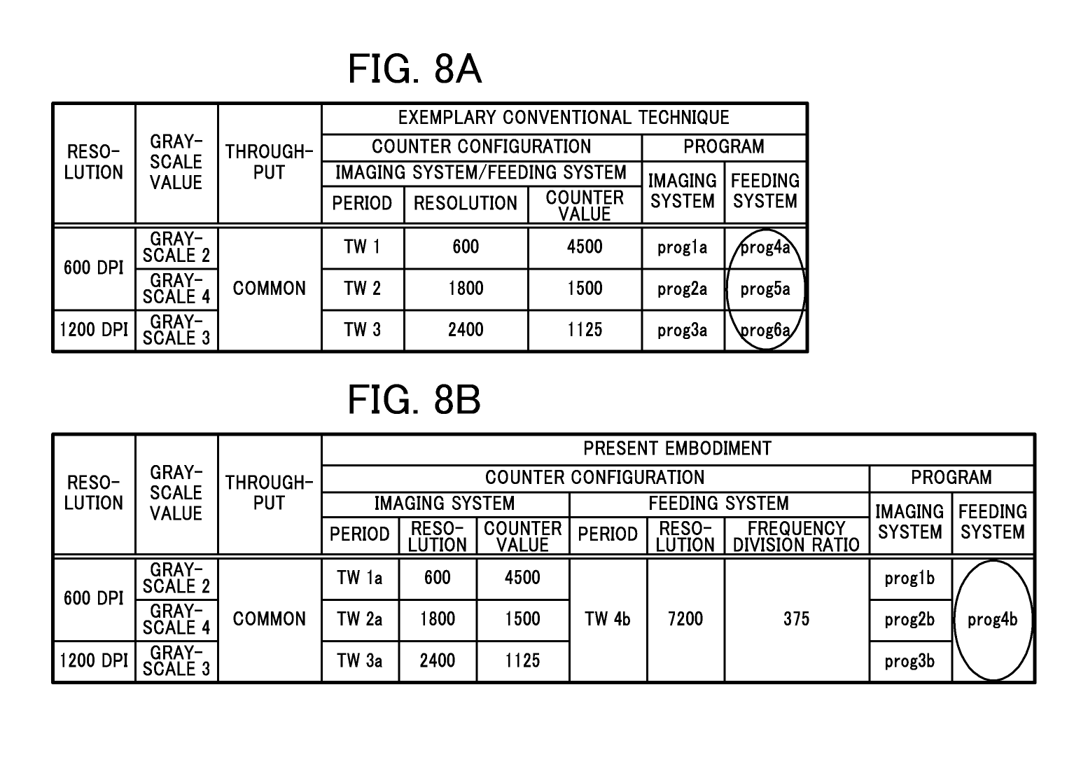

FIGS. 8A and 8B are diagrams (1 of 3) illustrating effects of the present embodiment. In a conventional technique, as illustrated in FIG. 8A, since a common counter can be used for the imaging system and the feeding system, three counters are used and three periods TW1 to TW3 are set for the counters. For program processing, the conventional technique requires three imaging system programs, prog1a to prog3a, and three feeding system programs, prog4a to prog6a, hence a total of six programs. In contrast, in the present embodiment, separate counters need to be provided for the imaging system and the feeding system, as illustrated in FIG. 8B. Accordingly, the number of counters is increased to four, and four periods TW1a to TW3a, and TW4b need to be set for the counters as well. For program processing, on the other hand, the present embodiment requires three imaging system programs, prog1b to prog3b, and only one feeding system program, prog4b, hence a total of only four programs. Thus, the present embodiment can simplify program processing. Furthermore, when switching from one mode to another among modes 1 to 3 in the conventional technique, not only switching an imaging system program but also switching a feeding system program is required, which slows printing speed. In this embodiment, switching a feeding system program is not required when switching from one mode to another among modes 1 to 3, and therefore printing speed can be increased as compared with the conventional technique.

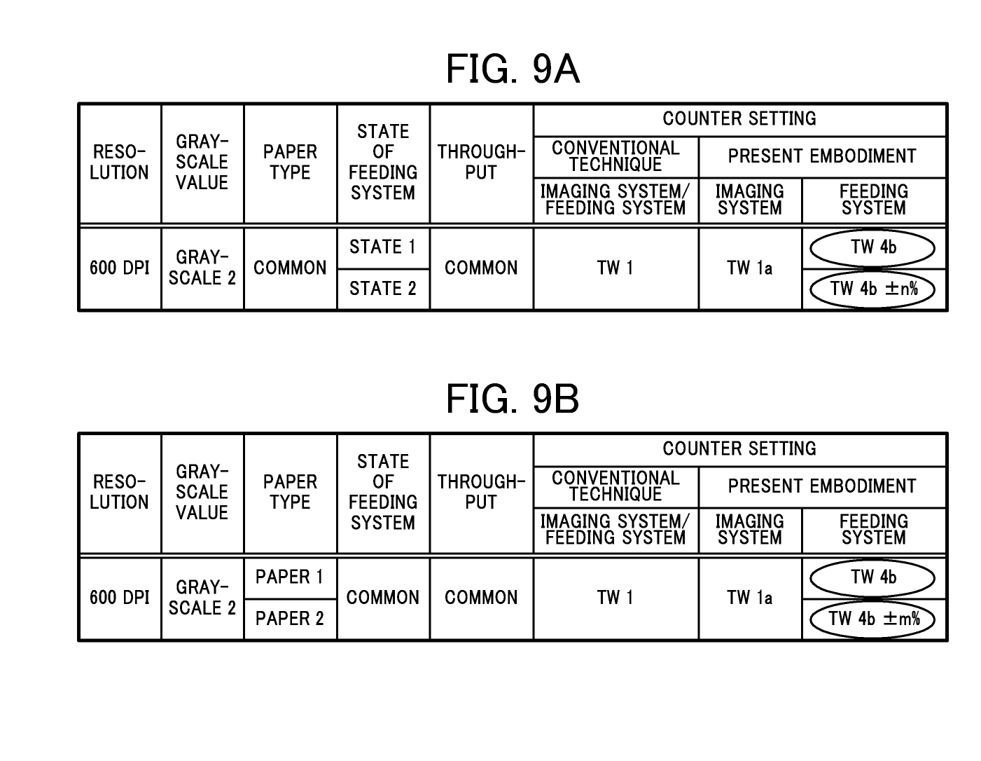

FIGS. 9A and 9B are diagrams (2 of 3) illustrating effects of the present embodiment. In a case of coping with an error due to thermal expansion of a roll diameter of the photoconductor drum 206 and the transfer belt 210 in FIG. 2, and the like, for example, caused by a temperature rise during printing, the feeding system synchronization signal TW4b is fine-adjusted (±n %) to control a frequency division ratio of the programmable frequency dividing counter 403 in FIG. 4 to provide a constant linear speed while the imaging system synchronization signal is maintained at TW1a as illustrated in FIG. 9A. This enables such an error as described above to be absorbed to keep the linear speed of the feeding system mechanism constant. Consequently, degradation of image quality due to thermal expansion and the like can be prevented. Similarly, when a type of paper for printing is changed from paper 1 to paper 2, the feeding system synchronization signal TW4b is fine-adjusted (±m %) to control a frequency division ratio of the programmable frequency dividing counter 403 in FIG. 4 so as to keep the linear speed constant while maintaining the imaging system synchronization signal at TW1a as illustrated in FIG. 9B, thereby enabling to cope with paper type change. With synchronization signals TW1, TW2 generated in the conventional technique, the feeding system synchronization signal /TWOUT cannot be independently fine-adjusted while maintaining the period of the imaging system synchronization signal /TWOUT constant.

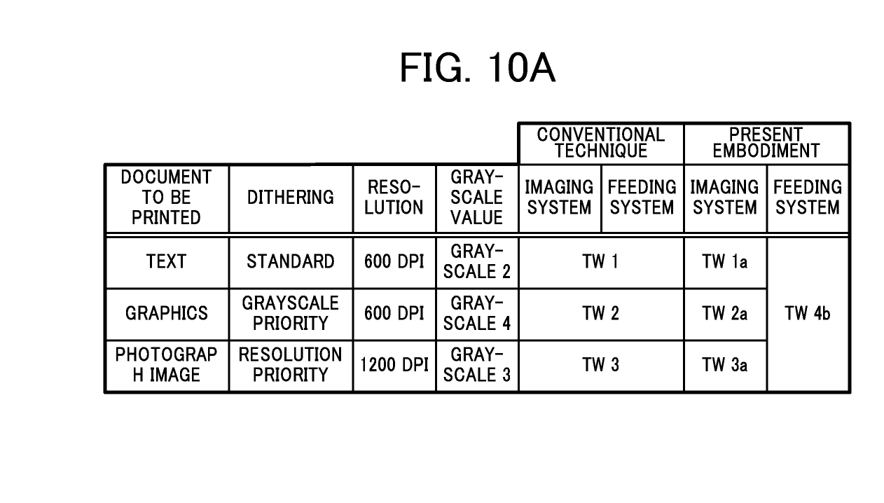

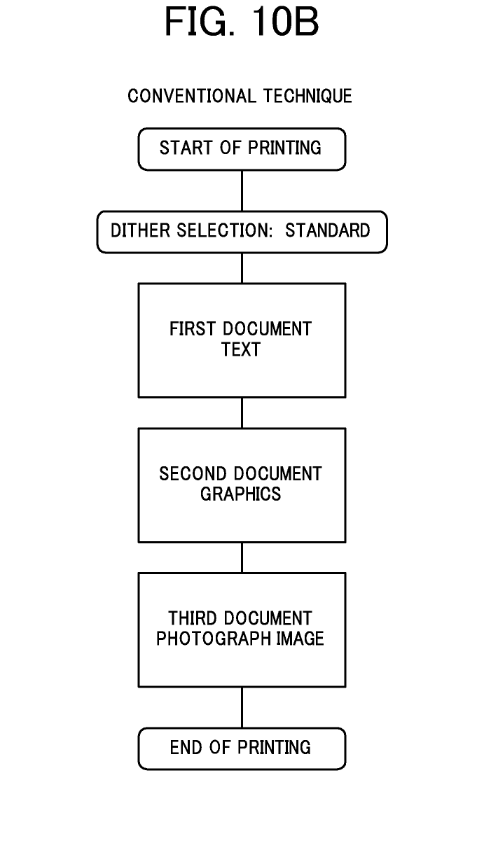

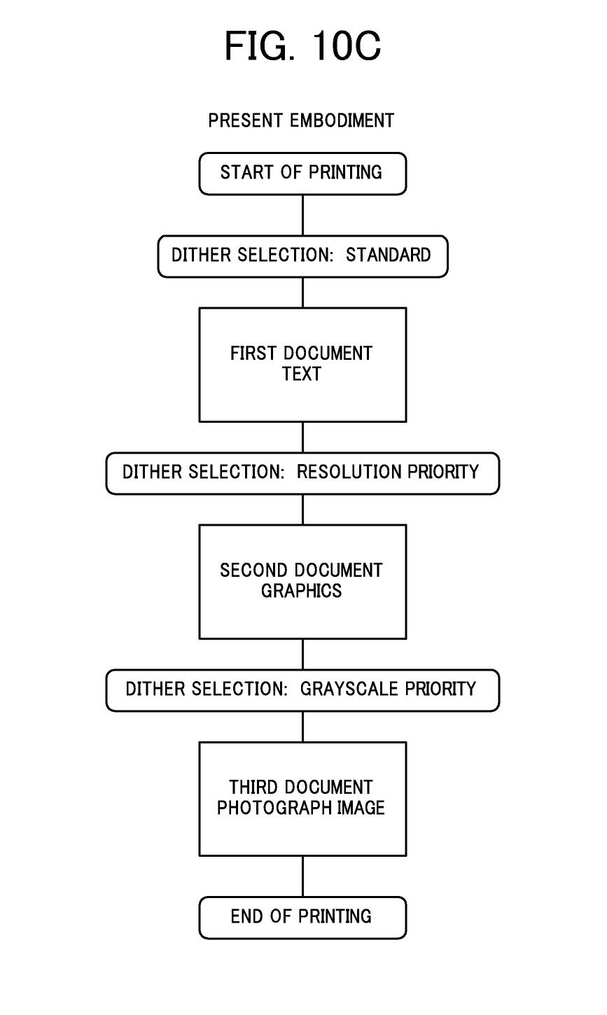

FIGS. 10A to 10C are diagrams (3 of 3) illustrating effects of the present embodiment. In the present embodiment, as illustrated in FIG. 10A, even when switching the imaging system synchronization signal /TWOUT in accordance with switching between a plurality of resolutions or grayscale values, the period of the feeding system synchronization signal /TWOUT can be maintained constant regardless of the resolutions or grayscale values. Accordingly, dithering can be changed in accordance with characteristics of a document to be printed even during a single print job, thereby providing image quality most suitable for the document. In the conventional technique, as illustrated in FIG. 10B, since dithering cannot be changed during a single print job, a dithering change needs to be performed while printing is not in progress. In the present embodiment, in contrast, the period of the feeding system synchronization signal /TWOUT does not need to be changed during printing, therefore, dithering can be changed by changing the period of the imaging system synchronization signal /TWOUT even at the timing of switching a page or during printing of one document page, without stopping continuous printing operation during a single print job, as illustrated in FIG. 10C.

Having described some embodiments of the present disclosure, the present disclosure is not limited to the embodiments described above but the present disclosure includes the disclosure in Claims and the equivalents coverage thereof.

What is claimed is:

1. An image formation apparatus comprising:
an image processing system mechanism which performs image processing on video data to generate head data for driving a head and controls the head using the head data to perform a printing process on a printing medium;
a feeding system mechanism which controls feeding of the printing medium during the printing process;
an imaging system synchronization signal generator which generates an imaging system synchronization signal for operating the image processing system mechanism;
a feeding system synchronization signal generator which operates in synchronization with the imaging system synchronization signal generator, the feeding system synchronization signal generator generating a feeding system synchronization signal for operating the feeding system mechanism;
an imaging system synchronization signal period setter which sets, as a plurality of periods of the imaging system synchronization signal, a first plurality of different periods being predetermined in accordance with a plurality of modes of the image processing, for the imaging system synchronization signal generator; and
a feeding system synchronization signal period setter which sets, as a period of the feeding system synchronization signal, a common single period being common to a plurality of modes of the image processing, for the feeding system synchronization signal generator.

2. The image formation apparatus according to claim 1,
wherein the feeding system synchronization signal period setter sets, as the period of the feeding system synchronization signal, for the feeding system synchronization signal generator, said period of the feeding system synchronization signal being such that a frequency corresponding to said period equals to a common multiple of a plurality of frequencies corresponding to the plurality of periods of the imaging system synchronization signal.

3. The image formation apparatus according to claim 1,
wherein the imaging system synchronization signal generator is a first counter counting up a counter value based on a first clock signal, the first counter outputting, as the imaging system synchronization signal, a signal an edge of which changes at a timing when the counter value reaches a reset counter value and is reset;
the imaging system synchronization signal period setter is a counter register, setting, as a plurality of the reset counter values, for the first counter, said plurality of the reset counter values being such that the plurality of periods of the imaging system synchronization signal being output from the first counter based on said reset counter value equal to the first plurality of different periods;
the feeding system synchronization signal generator is a second counter counting up a counter value based on the first clock signal or a second clock signal that is in synchronization with the first clock signal, the second counter outputting, as the feeding system synchronization signal, a signal an edge of which changes at a timing when the counter value is reset by a reset signal; and
the feeding system synchronization signal period setter is a programmable frequency dividing counter dividing a frequency of the first clock signal or the second clock signal at a frequency division ratio and outputting the reset signal, the frequency division ratio being set so that a period of the feeding system synchronization signal being output from the second counter equals to the common single period.

4. The image formation apparatus according to claim 1,
wherein the feeding system synchronization signal period setter sets, as a plurality of periods of the feeding system synchronization signal, for the feeding system synchronization signal generator, a second plurality of different periods being predetermined in accordance with a plurality of types of the printing medium or a plurality of linear speeds of the feeding system.

5. The image formation apparatus according to claim 1,
wherein the feeding system synchronization signal period setter sets, as the period of the feeding system synchronization signal, for the feeding system synchronization signal generator, a period being fine-adjusted to maintain linear speed of the feeding system constant regardless of a state of the feeding system mechanism.

6. The image formation apparatus according to claim 1,
wherein the imaging system synchronization signal period setter switches a period being set for the imaging system synchronization signal generator from one period among the first plurality of different periods to another during the printing process for a single print job; and
the feeding system synchronization signal period setter maintains a period being set for the feeding system synchronization signal generator constant at the common single period for entire duration of the printing process for the single print job, regardless of a period being set for the imaging system synchronization signal generator.

7. A computer readable non-transitory recording medium storing a control program for controlling an image formation apparatus comprising an image processing system mechanism performing image processing on video data to generate head data for driving a head and controlling the head using the head data to perform a printing process on a printing medium and a feeding system mechanism controlling feeding of the printing medium during the printing process, the control program causing a computer to:
generate an imaging system synchronization signal for operating the image processing system mechanism;
generate a feeding system synchronization signal being in synchronization with the imaging system synchronization signal, the feeding system synchronization signal for operating the feeding system mechanism;
set, as a plurality of periods of the imaging system synchronization signal, a first plurality of different periods being predetermined in accordance with a plurality of modes of the image processing; and
set, as a period of the feeding system synchronization signal, a common single period being common to a plurality of modes of the image processing.
